(19) United States
(12) Patent Application Publication
(10) Pub. No.: US 2018/0227754 A1
(43) Pub. Date: Aug. 9, 2018

(54) WEARABLE DATA DEVICE WITH DEACTIVATION SECURITY FEATURE

(71) Applicant: Yuri Luis Dario Paez Velazquez, Zapopan (MX)

(72) Inventor: Yuri Luis Dario Paez Velazquez, Zapopan (MX)

(21) Appl. No.: 15/364,525

(22) Filed: Nov. 30, 2016

Related U.S. Application Data
(60) Provisional application No. 62/265,521, filed on Dec. 10, 2015.

(51) Int. Cl. H04W 12/06; H04L 29/06; H04B 1/3827; H04L 29/08; H04W 4/00

(52) U.S. Cl. CPC H04W 12/06; H04L 63/0428; H04L 63/0861; H04W 84/12; H04B 1/385; H04L 67/306; H04W 4/008; H04L 63/107

(57) ABSTRACT

A wearable data device, for being worn by a user to facilitate access to transactions and actions that require authorization by the user. The data device contains a memory unit for storing user authentication credentials for external devices. When an external device is detected that matches the stored credentials, the user authentication credentials are shared wirelessly and automatically. The data device has a removal sensor for detecting a removal event when the wearable data device has been removed from the authorized user. Upon the occurrence of a removal event the data device is automatically de-authorized and deactivated such that it must be again authorized before it will wirelessly share the user authentication credentials.

### CROSS REFERENCES AND RELATED SUBJECT MATTER

This application is a non-provisional filing of provisional patent application Ser. No. 62/265,521, filed in the United States Patent Office on Dec. 10, 2015, which is incorporated herein by reference in its entirety.

### TECHNICAL FIELD

The present disclosure relates generally to a wearable data device. More particularly, the present disclosure relates to a wearable device that contains critical personal data, which is configured to automatically deactivate when removed from the wearer.

### BACKGROUND

In our increasingly technological world, a great deal of our daily activities and transactions involve computers and computerized devices. Many of these activities and transactions are secure, meaning they are intended only to be carried out by a user who is both identified and authorized.

The most common security scheme is to require a password. Often a user is permitted to make his own password, within certain constraints. Typical constraints include requiring both uppercase and lowercase letters, requiring numbers and special characters, and requiring a certain password length. Since these constraints vary, most people use distinct passwords for accessing different systems. In addition, since using the same password on multiple systems decreases its confidentiality, it is wise to use a distinct password with every individual system used.

Using a distinct password with every system will typically require that an individual have at least dozens of passwords. It is nearly impossible to memorize each one. Thus, different systems have been developed and conceived that help people to remember all of their passwords so that they are available when needed. Such password systems often require that a person enter a single passcode to gain access to all of their passwords.

In addition, wearable computer systems are becoming increasingly popular. In particular, watches that work in conjunction with smartphones are becoming increasingly integrated in our activities, transactions, and workflow. As such, they will often contain sensitive data. While many such devices provide a lock code feature, frequently entering the lock code can become cumbersome and inconvenient, and thus the lock code feature is often disabled—leaving the device unsecured.

While these units may be suitable for the particular purpose employed, or for general use, they would not be as suitable for the purposes of the present disclosure as disclosed hereafter.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

An aspect of an example embodiment in the present disclosure is to provide a wearable data device that is capable of storing personal data for the user, and providing such data when needed. Accordingly, the present disclosure provides a portable data device that may be worn on the body of a user, and contains both data storage components and wireless data communication components.

It is yet another aspect of an example embodiment in the present disclosure to provide a wearable device that is easily used by the user, but prevents unauthorized use by a person other than the user. Accordingly, when worn by the user the device is configured to wirelessly interface with devices in the proximity of the user. When a removal event is detected, indicating that the device has been removed from the user, however, the device is automatically deactivated and will cease interfacing with nearby devices until reactivated by the authorized user.

It is a further aspect of an example embodiment in the present disclosure to provide immediate and automatic access to devices and systems that require user authentication before performing a transaction or allowing an action, while requiring minimal interaction by the user. Accordingly, the data device detects nearby external devices, communicates wirelessly with nearby such external devices and automatically provides the user credentials when an appropriate device is detected.

Accordingly, the present disclosure describes a wearable data device, for being worn by a user to facilitate access to transactions and actions that require authorization by the user. The data device contains a memory unit for storing user authentication credentials for external devices. When an external device is detected that matches the stored credentials, the user authentication credentials are shared wirelessly and automatically. The data device has a removal sensor for detecting a removal event when the wearable data device has been removed from the authorized user. Upon the occurrence of a removal event the data device is automatically deauthorized and deactivated such that it must be again authorized before it will wirelessly share the user authentication credentials.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1 is a diagrammatic perspective view, illustrating an embodiment of the wearable data device, in the form of a wristwatch.

FIG. 2 is a diagrammatic perspective view, similar to FIG. 1, except wherein the data device is being removed from the wrist of the authorized user.

FIG. 3 is a diagrammatic perspective view, illustrating another embodiment of the data device, in the form of a bracelet.

FIG. 4 is a diagrammatic perspective view, similar to FIG. 3, except wherein the data device is being removed from the wrist of the authorized user.

FIG. 5 is a diagrammatic perspective view, illustrating an embodiment of the data device, in the form of a ring.

FIG. 6 is a block diagram, illustrating the functional interconnection of various components of the wearable data device.

FIG. 7 is a flow diagram, illustrating an aspect of operation of the data device.

FIG. 8 is a flow diagram, illustrating another aspect of operation of the data device.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

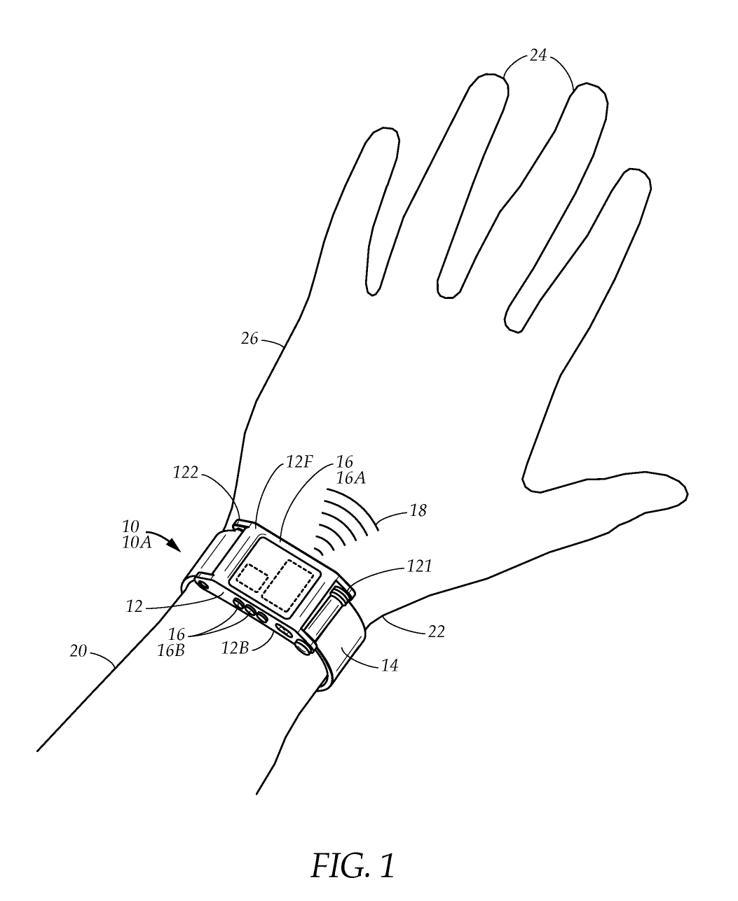

FIG. 1 illustrates a wearable data device 10 being worn by a user 20 having a wrist 22, fingers 24, and skin 26. The wearable data device 10 is provided in the form of a wristwatch 10A, having a housing 12 having a first side 121 and a second side 122, and a band 14 that is selectively attached to the first side 121 and second side 122, and together with the housing 12 encircles the wrist 22. The housing 12 has a front face 12F that is oriented away from the user 20, and an inward face 12B that is oriented toward the user 20. Referring generally to the various embodiments of FIG. 1-5, the housing 12 has a user interface 16, which may include a touchscreen 16A on the front face 12F that facilitates interaction with the user 20 and control of the data device 10 by the user 20. The user interface 16 may include additional control buttons 16B on the housing 12 to further allow control over functionality and modes of operation of the data device 10. The data device 10 is capable of transceiving a wireless data signal 18 with nearby external devices.

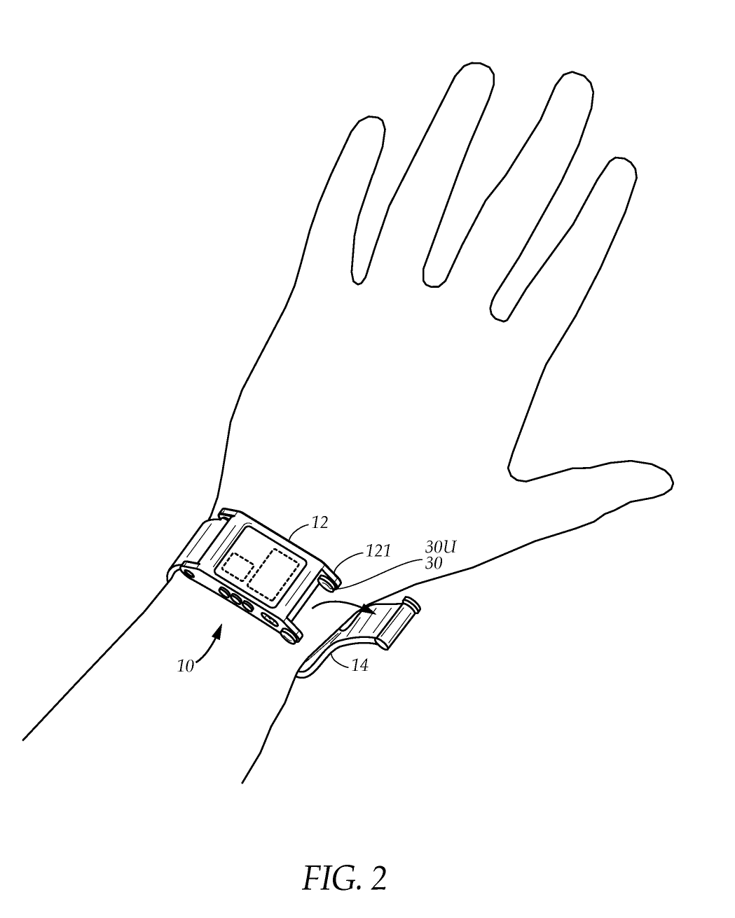

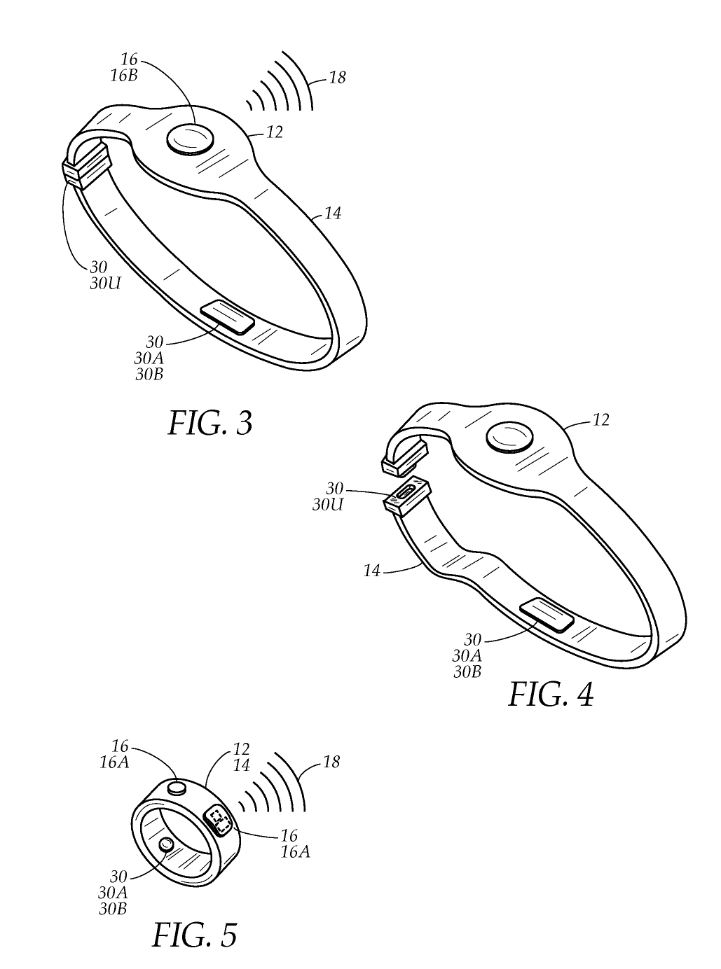

In FIG. 2, the wearable data device 10 is being removed from the user 20. In particular, the band 14 is being detached from the housing 12 at the first end 121, breaking continuity of the housing 12 and band 14 combination that normally encircles the wrist 22. To detect the removal or imminent removal of the device 10, the housing 12 has a removal sensor 30 to signal a removal event when such removal is detected. The removal sensor 30 in this embodiment may include an unplug sensor 30U, which directly senses the disconnection of mating components of the data device 10, such as the band 14 and housing 12. Referring to FIGS. 3 and 4, the wearable data device 10 is shown configured as a bracelet 10B. Note that the housing 12 and band 14 are nearly continuous or coincident in this embodiment. The removal sensor 30 may be or may include the unplug sensor 30U, to detect a discontinuity in the band 14 that indicates that the data device 10 is or is about to be removed from the user. Note that the removal sensor 30 may also be configured to directly sense the user, such as by being configured as a proximity sensor 30A on the inward face 12B that detects the sudden change in measured proximal distance when the device is moved from the skin. The removal sensor 30 may also be configured as a biometric sensor, wherein the biometric sensor 30B remains in continuous contact with the skin while the device is worn, and biometric data is thereby continually sensed. Such biometric data may include, for example, the skin temperature, skin resistance, and pulse of the user. Upon the sudden absence of such biometric data, a removal event may be triggered. In general, in the various embodiments, the housing 12 has an opening that allows a body part to be extended therethrough so that the data device may be worn. FIG. 5 provides another example in the form of a ring, where distinctions between the housing 12 and band 14 are further blurred, such that a continuous unit is created for encircling one of the fingers 24 (FIG. 1) of the user. In this embodiment, the removal sensor 30 most likely takes the form of a proximity sensor 30A or biometric sensor 30B, as the removal of a ring or similar jewelry typically does not involve an unplugging or unclasping, but a sliding action that will result in a sudden change, where the skin of the user against the sensor 30A, 30B is suddenly absent.

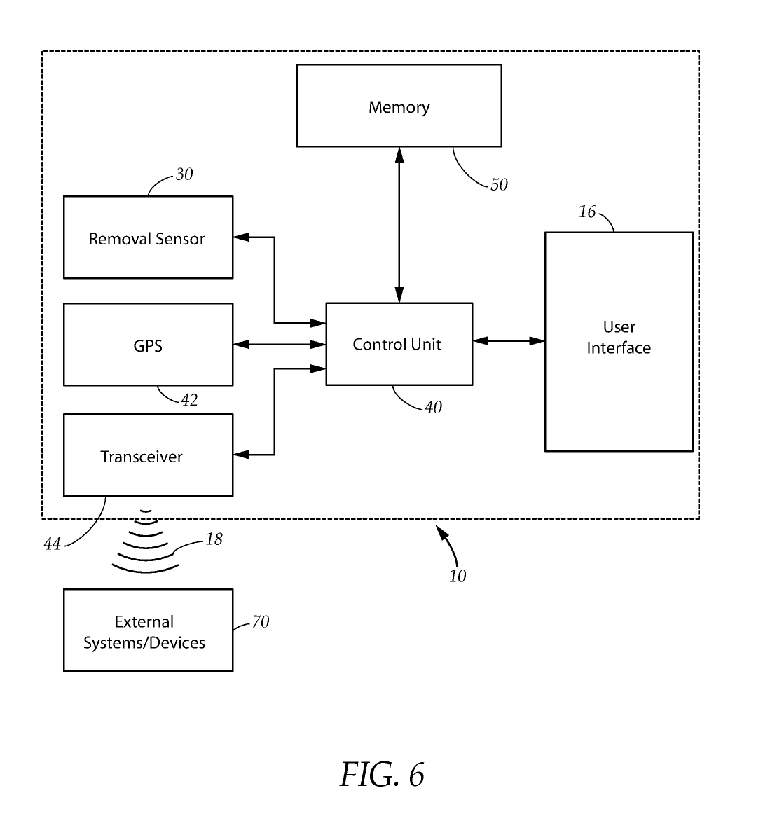

Referring to FIG. 6, the wearable data device 10 includes a control unit 40 that may include a microprocessor, microcontroller, or similar device for directing and facilitating the functionality described herein. The control unit 40 is connected with the user interface 16 to thereby facilitate interaction with the user as required. A GPS unit 42 may be provided within the data device 10. The GPS unit 42 self-locates, and provide GPS location data to the control unit 40 that reflects a precise location of the wearable data device 10. The user interface 16 and the removal sensor 30 are also connected to the controller 40. Further, a transceiver 44 is connected to the control unit 40. The transceiver is capable of connecting and communicating wirelessly with a variety of devices. The transceiver 44 can operate using any suitable wireless data communication protocol, including but not limited to WiFi, BLUETOOTH, and near field communication (NFC) protocols. The transceiver 44 thereby allows interconnection with external systems/devices 70 by wireless data signal 18. The external systems/devices 70 are computerized devices configured to receive data from the user, including passwords, encryption/de-encryption keys, and the like. Examples of such external devices 70 include electronic locks, personal computers, point of sale terminals, mobile phones, and any device that requires user identification and/or authority from the user to perform a transaction or some other action.

The wearable data device 10 includes a memory unit 50. The memory unit 50 can contain a variety of personal data, including confidential data, user credentials, and operating data for the memory unit 50. The memory unit 50 may also store encryption/de-encryption keys employed when transceiving data with various systems and devices. The user credentials can include user IDs, passwords, and other identifying data that is required by another system or device prior to performing an authorized action. Further, the removal sensor 30 is in communication with the control unit 40 to facilitate deactivation/de-authorization of the data device 10 when a removal event is sensed.

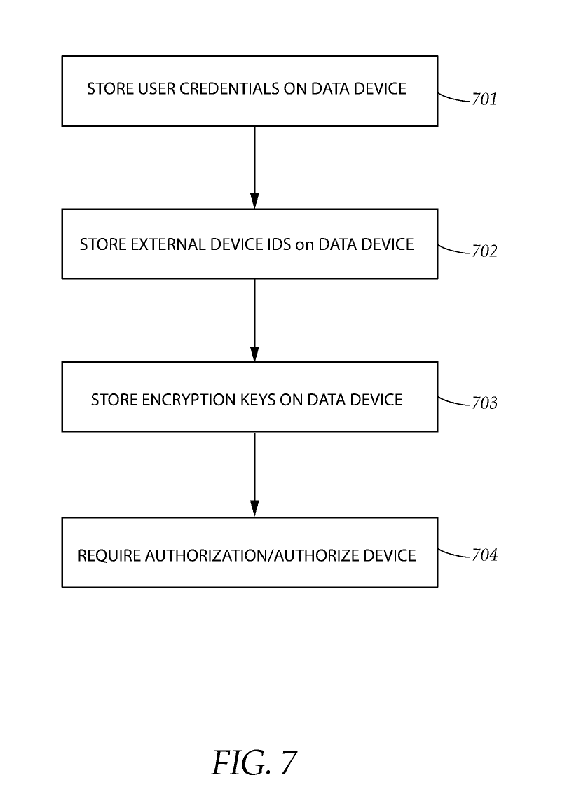

Referring to FIG. 7, initially user credentials may be stored on the data device 700. External Device IDs that uniquely identify external devices are also stored on the data device 701 in conjunction with the user IDs, passwords, and other user credentials associated therewith. Any encryption keys required when providing these user credentials are stored on the device in correlation with the appropriate external device IDs 702. Note that the external device IDs may be provided in numerous forms. These device IDs may be used to identify numerous systems and devices, both physical and virtual. For example, they may uniquely identify a physical device that the data device is presently interacting with. They may also refer to a system, such as a website, service, or remote server, that is remotely accessed through a physical device near the data device. In sum, they are configured to sufficiently indicate with what entity or entities the credential can/should be shared with. Once all such desired data is stored on the data device, the data device may be authorized for use 703. Authorizing the data device may be performed using an authorization procedure, which may be carried out in various ways to ensure that the data device is being operated by the authorized user, including through entering a code on the device itself, through verifying biometric information of the user, by connecting to a personal computing device or smartphone running an app that implements an authentication procedure, or through any suitable combination thereof.

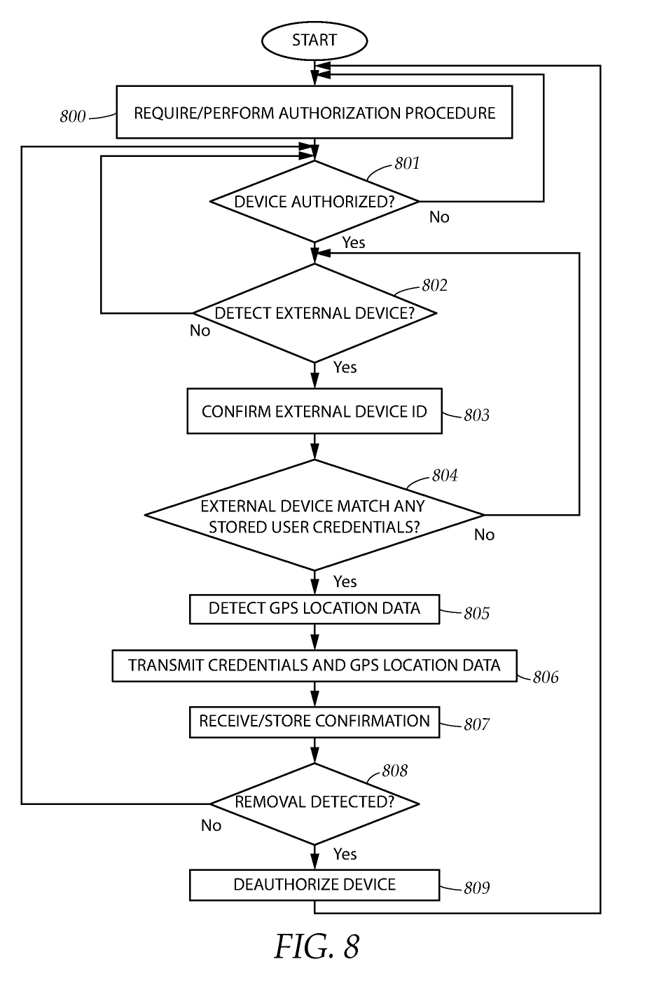

FIG. 8 provides an example of the user employing the data device to appropriately provide the user credentials contained thereon to various systems and devices to authorize/authenticate actions and activities by the user on such external devices and systems. To be operational, at least to the extent that it will exchange credentials with external devices/systems, the data device must itself be authorized. Accordingly, the device will require that device authorization be performed in order to be active, and will participate in conducting its authorization procedure 800. Further, before participating in the authentication of any activity or transaction, the data device will verify that it is authorized 801. While authorized or in an activated state, as the data device encounters external devices, it will detect such external devices 802 and confirm the external device ID of such devices 803, such that it will determine whether such external device matches any of the stored user credentials, and thus is suitable for sharing any of the stored user credentials 804. As an option to enhance verifying and recording and prevent fraud and misuse, the GPS location data is determined by the GPS unit in the data device 805, and the GPS location data is transmitted to the external device along with the user credentials 806. Note that, if required or requested by the particular external device/system, any encryption key stored in conjunction with the external device ID may be used in transmitting data to the external device/system and receiving data therefrom. A confirmation may be returned by the external device, which may be received and stored on the data device 807. In this way, the user can automatically authorize a transaction or other activity using the data device. For example, when activated, the data device can be carried by the user and is employed to open doors with electronic locks, unlock mobile devices and personal computers, provide access to websites, mobile applications, and make electronic payments while requiring only minimal action by the user or no action at all. The user is not required to use codes, passwords, and physical keys, and is only required to be within close range of the external device to facilitate wireless data communication and appropriate handshaking as described above. In some instances, however, the transaction may be optionally configured to employ the smartphone of the user or other mobile device of the user to complete a transaction.

In accordance with the principles of the present disclosure, the data device is continuously sensing for a removal event. If a removal is detected 808, the data device is immediately deauthorized 809, and made non-active at least as far as it will not share any stored user credentials while deauthorized. The data device will require the authorization procedure 800 before it will again detect and interface with external devices to share data credentials therewith.

Embodiments disclosed herein may be practiced using programmable digital computers configured to provide gaming experiences as described herein. An exemplary computer system includes at least one processor, such as an Intel Core™ or Xeon™ microprocessor or a Freescale™ PowerPC™ microprocessor, coupled to a communications channel. The computer system further can include an input device such as, e.g., a keyboard or mouse, an output device such as, e.g., a CRT or LCD display, a communications interface, a data storage device, such as a magnetic disk or an optical disk, and memory such as Random-Access Memory (RAM), each coupled to the communications channel. The transceiver may be coupled to a network such as the Internet.

One skilled in the art will recognize that, data storage devices and memory can be parts of the same unit or units, and that the functions of one can be shared in whole or in part by the other, e.g., as RAM disks, virtual memory, etc. It will also be appreciated that any particular computer may have multiple components of a given type, e.g., processors, input devices, communications interfaces, etc.

The data storage device and/or memory may store an operating system such as Microsoft Windows®, Linux®, Mac OS®, or Unix®. Other programs may be stored instead of or in addition to the operating system. It will be appreciated that a computer system may also be implemented on platforms and operating systems other than those mentioned.

Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system may also include additional components and/or systems, such as network connections, additional memory, additional processors, network interfaces, input/output busses, gaming controllers, for example. One skilled in the art will also recognize that the programs and data may be received by and stored in the system in alternative ways. For example, a computer-readable storage medium (CRSM) reader, such as, e.g., a magnetic disk drive, magneto-optical drive, optical disk drive, or flash drive, may be coupled to the communications bus for reading from a computer-readable storage medium (CRSM) such as, e.g., a magnetic disk, a magneto-optical disk, an optical disk, or flash RAM. Accordingly, the computer system may receive programs and/or data via the CRSM reader. Further, it will be appreciated that the term “memory” herein is intended to include various types of suitable data storage media, whether permanent or temporary, including among other things the data storage device, the memory, and the CSRM.

Computer systems may be connected, e.g., in one or more networks, via, e.g., network interfaces. According to an embodiment, the network is, for example, any combination of linked computers, or processing devices, adapted to transfer and process data. The computer network may be private Internet Protocol (IP) networks, as well as public computer networks, such as the Internet that can utilize World Wide Web (www) browsing functionality. The term “the Internet” refers to the worldwide network of interconnected, packet-switched data networks that use the Internet Protocol (IP) to route and transfer data. A client and server on different networks may communicate via the Internet. For example, a workstation may request a World Wide Web file from a Web Server. The Web Server may process the request and pass it to, e.g., an Application Server. The Application Server may then conduct further processing, which may include, for example, sending data to and/or receiving data from one or more other data sources. Such a data source may include, e.g., other servers on the same network or a different one and/or a Database Management System (“DBMS”).

An example of a wired network is a network that uses communication busses and MODEMS, or DSL lines, or a local area network (LAN) or a wide area network (WAN) to transmit and receive data between terminals. An example of a wireless network is a wireless LAN. A cellular network such as Global System for Mobile Communication (GSM) and Enhanced Data rates for GSM Evolution (EDGE) or LTE Advanced is another example of a wireless network. Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers. Yet, other examples of a wireless network may include a 3G communication network or a 4G or 5G communication network. Yet another example of a wireless network is near field communication (NFC)—a set of short-range wireless technologies. NFC typically operated at a distance of 4 cm or less at rates ranging from 106 kbit/s to 848 kbit/s. NFC involves an initiator that generates an RF field, which in turn powers a passive target. The NFC target can take simple form factors such as tags, stickers, key fobs, or cards that do not require batteries, but can also be used in conjunction with smart cards or phones incorporating NFC functionality.

A network may, for example, connect one or more terminals or clients with each other and with other computer systems, such as file servers or mail servers. The connection may be achieved tangibly, e.g., via Ethernet® or optical cables, or wirelessly, e.g., through use of modulated microwave signals according to the IEEE 802.11 family of standards. A computer system that participates in the network may send data to another computer system in the network via the network connection.

One use of a network is to enable a computer system to provide services to other computer systems, consume services provided by other computer systems, or both. For example, a file server may provide common storage of files for one or more of the computers on a network. A computer sends data including a request for a file to the file server via the network and the file server may respond by sending the data from the file back to the requesting computer.

A network may be connected to one or more other networks, e.g., via a router. A router may also act as a firewall, monitoring and/or restricting the flow of data to and/or from a network as configured to protect the network. A firewall may alternatively be a separate device (not pictured) from the router.

Systems and modules described herein may comprise software, firmware, hardware, or any combination(s) of software, firmware, or hardware suitable for the purposes described herein. Software and other modules may reside on servers, workstations, personal computers, computerized tablets, PDAs, gaming devices, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

It will be appreciated from the above that the invention may be implemented as computer software, which may be supplied on a storage medium or via a transmission medium such as a local-area network or a wide-area network such as the Internet. It is to be further understood that, because some of the constituent system components and method steps depicted in the accompanying Figures and otherwise herein can be implemented in software, the actual connections between the systems components (or the process steps) may differ depending upon the manner in which the present invention is programmed. Given the teachings provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device.

The application program can be uploaded to, and executed by, a machine comprising any suitable architecture.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein, it is to be understood that the invention is not limited to those precise embodiments, and that various changes and modifications can be effected therein by one skilled in the art without departing from the scope and spirit of the invention.

It is further understood that, although ordinal terms, such as, “first,” “second,” “third,” are used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In conclusion, herein is presented a wearable data device having a deactivation feature for detecting device removal from the user and preventing unauthorized use of the device. The disclosure is illustrated by example in the drawing figures, and throughout the written description. It should be understood that numerous variations are possible, while adhering to the inventive concept. Such variations are contemplated as being a part of the present disclosure.

1. A wearable data device, for being worn by a user to facilitate access to transactions and actions that require authorization by the user, comprising:
a housing having an opening so that the housing is adapted to be worn on a body part of the user;
a removal sensor, the removal sensor comprises a receptacle mating component and a plug mating component which is detachably connected to the receptacle mating component, the removal sensor is adapted to directly detect a disconnection between the plug mating component and the receptacle mating component, and register a removal event upon detecting the disconnection;
a memory unit for storing user credentials that facilitate authorization; and
a transceiver for detecting an external device having a device ID that matches user credentials stored in the memory unit and transmitting said user credentials to an external device unless the removal event is detected by the wearable data device.

2. The wearable data device as recited in claim 1, further comprising a GPS unit, for determining GPS location data, and wherein the transceiver transmits the GPS location data along with the user credentials.

3. The wearable data device as recited in claim 2, wherein the housing is configured as an item in the group consisting of a wristwatch, a bracelet, and a ring.

4. The wearable data device as recited in claim 3, wherein the user credentials include the device ID of the external device and a username and password associated with the device ID.

5. The wearable data device as recited in claim 4, wherein after the removal event is detected the transceiver requires that the user authenticate the device before the transceiver will again share the user credentials with any external device.

6. The wearable data device as recited in claim 5, wherein the wearable data device further comprises a second removal sensor selected from the group consisting of a proximity sensor and a biometric sensor, the second removal sensor is adapted to detect the removal event corresponding to the wearable data device being separated from the body part of the user.

7. A wearable data device authentication method, for use by a user having a body, employing a wearable data device having a removal sensor, the removal sensor comprising a receptacle mating component and a plug mating component which is detachably connected to the receptacle mating component, comprising the steps of:
(a) wearing the data device on the body of the user;
(b) authorizing the data device by performing an authorizing procedure;
(c) matching a nearby device with credentials stored on the device by wirelessly determining a device ID of a nearby external device;
(d) transmitting credentials associated with said device ID from the data device to said external device;
(e) detecting removal of the data device from the body of the user by detecting a disconnection between the plug mating component and the receptacle mating component; and
(f) requiring authorization of the data device by the user before repeating steps (c) and (d).

8. The wearable data device authentication method as recited in claim 7, wherein the data device has a second removal sensor, and wherein the step of detecting removal of the data device from the body of the user is further performed by the second removal sensor.

9. The data device authentication method as recited in claim 8, wherein the step of wirelessly determining the device ID of the nearby external device further comprises determining GPS location data of the wearable data device, and wherein the step of transmitting credentials associated with that device ID further comprises transmitting the GPS location data to the external device.

10. The data device authentication method as recited in claim 9, wherein the data device is configured as an item selected from the group consisting of a wristwatch, a bracelet, and a ring, and wherein the second removal sensor is selected from the group consisting of a proximity sensor and a biometric sensor.

11. The data device authentication method as recited in claim 10, wherein an encryption key is stored on the data device along with the credentials associated with the device ID and wherein the step of transmitting credentials associated with that device ID further comprises transmitting encrypted credentials.

12. A wearable data device authentication method, for use by a user having a body, employing a wearable data device having a removal sensor, the removal sensor comprising a receptacle mating component and a plug mating component which is detachably connected to the receptacle mating component, comprising the steps of:
wearing the data device on the body of the user;
detecting removal of the data device from the body of the user by detecting a disconnection between the plug mating component and the receptacle mating component;
searching wirelessly for a nearby external device having a device ID that matches credentials stored on the data device; and
transmitting credentials associated with said device ID from the data device to said external device if removal of the data device has not been detected by the removal sensor.

13. The wearable data device authentication method as recited in claim 12, wherein the step of detecting removal of the data device is followed by the step of requiring an authorization procedure by the data device.

14. The wearable data device authentication method as recited in claim 13, wherein an encryption key is stored on the data device along with the credentials associated with the device ID and wherein the step of transmitting credentials associated with the device ID further comprises transmitting encrypted credentials.

15. The wearable data device as recited in claim 14, wherein the data device is configured as an item selected form the group consisting of a wristwatch, a bracelet, and a ring, and wherein the removal sensor further comprises a second sensor adapted to detect the removal of the data device from the body of the user, the second sensor is selected from the group consisting of a proximity sensor and a biometric sensor.

16. The wearable data device as recited in claim 15, wherein the step of searching wirelessly for the nearby external device having the device ID that matches credentials stored on the data device further comprises determining GPS location data of the wearable data device, and wherein the step of transmitting credentials associated with that device ID further comprises transmitting the GPS location data to the external device.

17. The wearable data device as recited in claim 16, wherein the step of transmitting credentials to the external device further comprises communicating wirelessly using a communication protocol selected from the group consisting of WiFi, BLUETOOTH, and near field communication.

18. The wearable device as recited in claim 5, wherein the housing is configured as the wristwatch, the wristwatch comprises a watch body and a strap; wherein the watch body comprises a strap hinge, the strap comprises a strap mating component, and the strap mating component is detachably connected to the strap hinge; and wherein the removal sensor detects the detaching of the strap mating component from the strap hinge, and the detaching of the strap mating component from the strap hinge corresponds to the removal event.
